(19) United States
(12) Patent Application Publication
(10) Pub. No.: US 2026/0148116 A1
(43) Pub. Date: May 28, 2026

(54) Method for Producing a Decision Aid for Deciding Whether Unscheduled Maintenance Should Be Carried Out At a Production Station

(71) Applicant: Bayerische Motoren Werke Aktiengesellschaft, Muenchen (DE)

(72) Inventor: Sebastian SCHNEIDER, Erding (DE)

(21) Appl. No.: 19/105,139

(22) PCT Filed: Sep. 27, 2023
(86) PCT No.: PCT/EP2023/076698

§ 371 Date: Feb. 20, 2025

(30) Foreign Application Priority Data
Oct. 12, 2022 (DE) 10 2022 126 563.3

(51) Int. Cl. G06N 5/045

(52) U.S. Cl. CPC G06N 5/045

(57) ABSTRACT

A method produces a decision aid for deciding whether unscheduled/unscheduled maintenance should be carried out at a production station of a production line during a production process. The production station is designed to produce a total count of parts per unit time. The production station has a defect rate of defectively produced parts per unit of time. A remaining time until the next scheduled maintenance is determined. A reject count of defective parts until the next scheduled maintenance is determined based on the total count, the remaining time, and the defect rate. A maintenance time to maintain the manufacturing station is determined. A failure count of non-produced parts during the maintenance time is determined based on the total number and the maintenance time. The reject count is compared with the failure count. The decision aid is displayed based on the comparison.

### BACKGROUND AND SUMMARY

The invention relates to a method for producing a decision aid for deciding whether unscheduled maintenance should be carried out on at least one production station of a production line during a production process or whether scheduled maintenance should be carried out. The method further relates to a system, a computer program product and a vehicle having a vehicle part which is manufactured in a production line in which it has been decided, by means of a method for producing a decision aid, whether scheduled maintenance or unscheduled maintenance should be carried out.

Complex production lines, such as, for example, paint lines in battery cell painting, normally consist of a plurality of production stations in which separate, and in some cases physically separate, production processes are carried out in the value-added line of the final product. Here, the production station can be, for example, a value-adding station in which a production step is carried out, or it can involve an acceptance test. A production line within the meaning of this invention can be designed such that it comprises only one production station. Here, the single production station simultaneously represents the entire production line. Generally speaking, however, it is customary for a production line, as described above, to comprise a plurality of production stations.

The production line is designed to produce parts. The term “parts” is understood to mean, for example, constituent parts of individual components or vehicle parts consisting of a plurality of components, such as, for example, a battery module. One example of a production line is a paint line for battery cell painting, a module line, a storage line or a production line which exists outside the electrification.

The production line is designed to produce a specific number of parts per hour according to a theoretical overall equipment effectiveness. The hour time unit is cited here merely as an example of a standard time unit. Further possible time units are, for example, minutes or days.

The theoretical overall equipment effectiveness is also referred to by the acronym OEE. The production line itself produces a total number of parts per hour which lies below the overall equipment effectiveness. The total number is intended, for example, to be no less than 75% of the overall equipment effectiveness. Generally speaking, the overall equipment effectiveness is reduced, for example, by defectively produced parts or an increased cycle time.

Defectively produced parts are parts that are produced outside a production specification. These parts are often denoted “not OK”, or “NOK” for short. The number of defectively produced parts per time unit of a production station forms the reject count. This reject count can be indicated as a percentage of the total count. It should be noted here that a part defectively produced in a production station can simultaneously also result in a defectively produced part of a production line. This occurs, in particular, if a plurality of subsequent production steps are carried out on a part successively in a plurality of production stations. The information indicating that a part has been defectively produced in a production station can be communicated directly to a monitoring system or to an operator. As a result, an immediate display is possible, indicating that a specific manufacturing process is running away. The term “running away” is understood to mean that the number of defectively produced parts in a production station is increasing, in particular is increasing above an acceptable value.

In order to ensure that the production stations of a production line produce parts according to the production specification over, for example, the entire life cycle of the production line, the production stations are regularly maintained at planned maintenance intervals. To do this, the planned maintenance intervals are usually scheduled such that said maintenance is carried out, for example, after a shift or during a rest period in which no parts are produced. Consequently, the planned maintenance does not affect the number of parts produced during a production process.

A single production process extends between two planned maintenance intervals. Parts are produced during this time, provided that no unscheduled maintenance is to be carried out.

Unscheduled maintenance is maintenance that has to be carried out during a production process. Here, at least the production station that is to be maintained must stop production so that maintenance can be carried out. The entire production line is usually affected here, such that all production stations have to interrupt the production process. Unscheduled maintenance extends over a maintenance time. No parts can be produced during this maintenance time. The number of parts that are lost through non-production consequently increases. Unscheduled maintenance is usually carried out if the defect rate increases on a production station during a production process. Following the unscheduled maintenance, the production line is restarted and the production process is continued until the next planned maintenance.

However, the problem arises here that, particularly in the case of a multiplicity of production stations, it is not easy to estimate whether it is appropriate to carry out unscheduled maintenance during a production process before the scheduled maintenance.

In this respect, a method for predicting the average time span between two failures of a production plant is known from EP 1 959 325 82. The method serves above all to predict the frequency of unplanned failures and the associated downtimes.

EP 2 837 984 82 discloses a method for optimized scheduling of planned maintenance work on a windfarm. The availability and life cycle of the wind turbine is intended to be extended thereby.

WO 2011/054005 A2 discloses a method for automated prediction of planned maintenance work on tools. For this purpose, possible available maintenance data relating to the maintenance work on a tool are known. Optimized scheduling of maintenance of a plurality of tools can be carried out on the basis of this information.

An object of the invention is to provide a method by means of which the number of produced parts can be maximized during a production process. At least this object is achieved by way of one or more features of the embodiments described herein.

At least one embodiment of a method for producing a decision aid for deciding whether unscheduled maintenance should be carried out on at least one production station of a production line during a production process or whether scheduled maintenance should be carried out. The production station is configured to produce a total count of parts per time unit, and has a defect rate of defectively produced parts per time unit. The method comprises the following steps:
a) determining a remaining time until the next scheduled maintenance;
b) determining a reject count of defective parts until the next scheduled maintenance based on the total count, the remaining time and the defect rate;
c) determining a maintenance time to maintain the production station;
d) determining a failure count of non-produced parts during the maintenance time based on the total count and the maintenance time;
e) comparing the reject count with the failure count; and
f) displaying the decision aid based on the comparison.

The method according to at least one embodiment offers the advantage that the operator is provided with support such that more parts can be produced according to the defined product specification if unscheduled maintenance is carried out, compared with continuing the production process with an increased defect rate until the planned maintenance. Particularly since it normally takes approximately 20 min until such a decision is made, the decision-making is substantially simplified by the proposed method and is accelerated as a result. The operator can therefore decide immediately whether scheduled maintenance is to be carried out or not.

In one advantageous development, the reject count is formed by the product of the total count, the remaining time and the defect rate, wherein the total count is indicated in parts per time unit, the remaining time in the same time unit, and the defect rate as a percentage of the total count.

An operator is, for example, a foreman in a works who is responsible for a production line.

In one advantageous embodiment of the method, a decision aid is displayed, deciding that unscheduled maintenance is to be carried out if the reject count is greater than or equal to the failure count.

As a result, a clear boundary can be introduced as a decision aid. The question of whether continued production with an increased defect rate or an unscheduled maintenance stoppage is to be carried out can thus be closely monitored.

The duration of the maintenance time is advantageously defined by a specific defect. The maintenance time and the duration of unscheduled maintenance can be distinguished from one another depending on the maintenance work to be carried out. The production station to be maintained can similarly be a factor that defines the duration of unscheduled maintenance. In this respect, the duration of corresponding unscheduled maintenance or the length of the maintenance time is generally known in advance through statistical observations. The duration of a maintenance time normally extends over 10 min, 20 min or 60 min. Consequently, determination of a maintenance time means, for example, that the production station having an increased reject rate is determined, and the maintenance time for the production station is determined from a database.

The decision aid is advantageously displayed in a graphical representation. A graphical representation particularly advantageously enables an intuitive representation, so that an operator can see at a glance whether unscheduled maintenance is to be carried out or not. The graphical representation can have two axes. The time until the next maintenance is shown on the y-axis, and the defect rate is shown on the x-axis.

The decision aid advantageously indicates a decision point at which the reject count is equal to the failure count. The decision point provides clear assistance and represents a simple and visual decision aid for an operator. In a graphical representation, the decision point can be a line having a regressive course.

The reject count advantageously comprises the count of produced parts which are outside a defined product specification. In the case of a production station which produces, for example, different parts or parts intended for different uses, it may be that the product specifications differ from one another. Consequently, the decision as to whether a part lies outside a product specification can vary. The defined product specification therefore allows detailed consideration.

The production line advantageously comprises at least two production stations. Complex production stations in particular have more than one production station. Monitoring and a decision aid are particularly advantageous here in particular, given that, due to the multiplicity of production stations and different maintenance times, it is difficult for an operator to assess whether unscheduled maintenance is to be carried out or not simply on the basis of his experience.

A further aspect relates to a system for data processing, comprising means to carry out the steps of the previously described method.

A further aspect relates to a computer program product, comprising commands which, when the program is executed by a computer, cause the computer to carry out the previously described method.

A further aspect relates to a vehicle having a vehicle part which is manufactured in a production line in which it has been decided by means of a method for producing a decision aid, as described above, whether scheduled maintenance or unscheduled maintenance is to be carried out.

These and other features and advantages are described in detail herein in connection with the drawings.

### BRIEF DESCRIPTION OF THE DRAWINGS

FIG. 1 shows a production line comprising production stations;

FIG. 2 shows a graphical representation displaying a decision aid according to the invention; and

FIG. 3 shows the graphical representation according to FIG. 2 with highlighted areas.

### DETAILED DESCRIPTION OF THE DRAWINGS

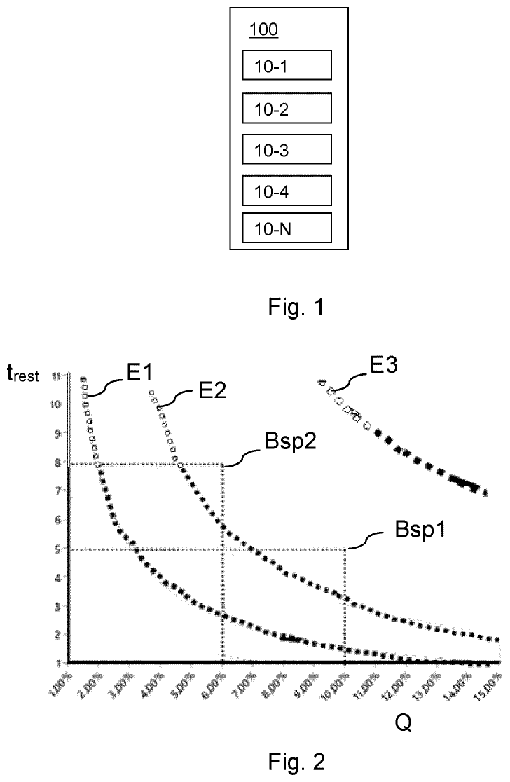

FIG. 1 shows a production line 100 comprising a plurality of production stations 10, i.e. a first production station 10-1, a second production station 10-2, a third production station 10-3, a fourth production station 10-4 and an Nth production station 10-N, where N indicates that any number of further production stations can be included.

The production line 10 produces a total count X of parts per hour. Here, the respective production station 10 has a defect rate Q of defectively produced parts per hour. A remaining time tᵣₑₛₜ remains until the next scheduled maintenance. A reject count xₐᵤₛ is calculated on the basis of the following formula, wherein the individual factors X, Q, tᵣₑₛₜ are multiplied by one another.

$${X}_{aus} = ( X \cdot Q ) \cdot {t}_{rest}$$

The total count X is indicated here in parts per hour, the defect rate as a percentage of the total count X, and the remaining time tᵣₑₛₜ in hours.

Unscheduled maintenance requires a maintenance time t_{wart}. Parts can be produced here in the production line 100. The count of parts not produced in this time is a failure count x_{nicht}. The failure count x_{nicht} is calculated by multiplying the maintenance time t_{wart} by the total count X. In one possible embodiment, the defect rate Q can also be taken into account in calculating the failure count x_{nicht}.

The failure count x_{nicht} is compared with the reject count Xₐᵤₛ for the decision aid. The performance of unscheduled maintenance is recommended as soon as the reject count Xₐᵤₛ is greater than or equal to the failure count x_{nicht}.

FIG. 2 shows a graphical representation of a production line, indicating on a display screen of a PC whether unscheduled maintenance is to be carried out during a production process or scheduled maintenance is to be carried out on at least one production station 10 of production line 100.

The graphical representation has an x-axis and a y-axis. The x-axis indicates, at equal intervals, the defect rate Q. The defect rate Q indicates the defectively produced parts per hour. In the present embodiment, the defect rate Q is indicated as a percentage of the total count X. The y-axis indicates, at equal intervals, the remaining time tᵣₑₛₜ in hours until the next scheduled maintenance. The values shown on the x-axis and on the y-axis are also interchangeable.

The graphical representation further has three regressively running lines which in each case represent a decision point E1, E2, E3. If the production line produces parts at a specific time, resulting in a value which lies in an area to the left of the decision point E1, E2 or E3, as shown in FIG. 2, continued production is recommended. If the production line produces parts at a specific time, resulting in a value which lies in an area to the right of the decision point E1, E2 or E3, as shown in FIG. 2, the performance of unscheduled maintenance is recommended.

The first decision point E1 represents a line at which the reject count Xₐᵤₛ is equal to the failure count x_{nicht} with a maintenance time t_{wart} of 10 minutes. The second decision point E2 represents a line at which the reject count Xₐᵤₛ is equal to the failure count x_{nicht} with a maintenance time t_{wart} of 20 minutes. The third decision point E3 represents a line at which the reject count Xₐᵤₛ is equal to the failure count x_{nicht} with a maintenance time t_{wart} of 60 minutes.

The following examples are described for clarification purposes.

In a first example, the remaining time tᵣₑₛₜ is 5 hours. The production line 10 has a defect rate Q of 10%. The reject count Xₐᵤₛ is 700 parts. With a maintenance time t_{wart} of 60 min, the failure count x_{nicht} is 1323 parts. The maintenance time t_{wart} is defined on the basis of the determined defect of the production station 10. Here, a maintenance time t_{wart} of 60 min is required.

With a maintenance time t_{wart} of 60 min, the reject count Xₐᵤₛ is less than the failure count x_{nicht}. Based on the remaining time tᵣₑₛₜ and the defect rate Q, the graph shows a point Bsp1 which is located to the left of the third decision point E3 for a 60-minute unscheduled maintenance. The recommendation is consequently not to carry out any unscheduled maintenance and instead to continue production with an increased defect rate Q until the next planned maintenance.

In a second example, the remaining time tᵣₑₛₜ is 8 hours. The production line 10 has a defect rate of 6%. The reject count Xₐᵤₛ is 1100 parts. With a maintenance time t_{wart} of 20 min, the failure count x_{nicht} is 770 parts. The reject count Xₐᵤₛ is greater than the failure count x_{nicht}. Based on the remaining time tᵣₑₛₜ and the defect rate of 6%, the graph shows a point Bsp2 which is located to the right of the third decision point E2 for a 20-minute unscheduled maintenance. The recommendation is consequently to carry out unscheduled maintenance.

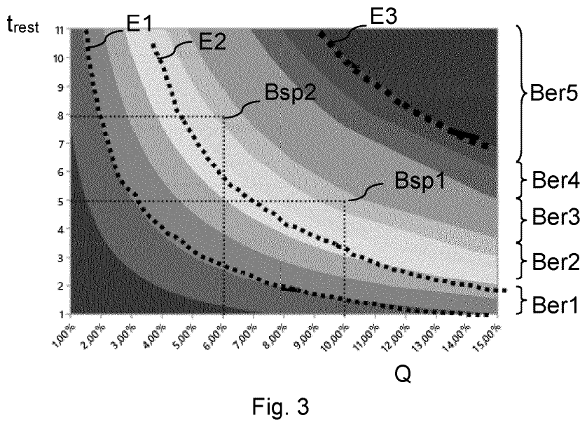

The graphical representation according to FIG. 3 differs in that additional areas Ber1, Ber2, Ber3, Ber4, Ber5 are indicated in the graph. The first area Ber1 shows, in a uniform color, a reject count Xₐᵤₛ between 0 and 200 parts of defectively produced parts. The second area Ber2 shows, in a uniform color, a reject count Xₐᵤₛ between 201 and 400 parts of defectively produced parts. The third area Ber3 shows, in a uniform color, a reject count Xₐᵤₛ between 401 and 600 parts of defectively produced parts. The fourth area Ber4 shows, in a uniform color, a reject count Xₐᵤₛ between 601 and 700 parts of defectively produced parts. The fifth area Ber5 shows, in a uniform color, a reject count Xₐᵤₛ between 701 and more parts of defectively produced parts.

It is particularly advantageous if the current values of the production line are displayed live in the graphical representation. It is further preferred that the history is similarly displayed.

The graphical representation provides a simple and intuitive decision aid.

### REFERENCE SIGN LIST

10 Production station
10-1 First production station
10-2 Second production station
10-3 Third production station
10-4 Fourth production station
10-N Nth production station
100 Production line
X Total count of parts per time unit
Q Defect rate of defectively produced parts per time unit
tᵣₑₛₜ Remaining time
Xₐᵤₛ Reject count
t_{wart} Maintenance time
x_{nicht} Failure count
E1 Decision point
E2 Decision point
E3 Decision point
Bsp1 Example 1
Bsp2 Example 2
Ber1 Area 1
Ber2 Area 2
Ber3 Area 3
Ber4 Area 4
Ber5 Area 5

1-10. (canceled)

11. A method for producing a decision aid for deciding whether unscheduled maintenance should be carried out on at least one production station of a production line during a production process, wherein the production station is configured to produce a total count of parts per time unit, wherein the production station has a defect rate of defectively produced parts per time unit, wherein the method comprises:
a) determining a remaining time until the next scheduled maintenance;
b) determining a reject count of defective parts until the next scheduled maintenance based on the total count, the remaining time and the defect rate;
c) determining a maintenance time to maintain the production station;
d) determining a failure count of non-produced parts during the maintenance time based on the total count and the maintenance time; and
e) comparing the reject count with the failure count and displaying the decision aid based on the comparison.

12. The method of claim 11, further comprising:
indicating that unscheduled maintenance is to be carried out if the reject count is greater than or equal to the failure count.

13. The method of claim 11, wherein the duration of the maintenance time is defined by a specific defect.

14. The method of claim 11, wherein the decision aid is displayed in a graphical representation.

15. The method of claim 11, wherein the decision aid indicates a decision point at which the reject count is equal to the failure count.

16. The method of claim 11, wherein the reject count comprises the count of produced parts which are outside a defined product specification.

17. The method of claim 11, wherein the production line comprises at least two production stations.

18. A non-transitory computer readable medium having instructions stored thereon that when executed by a computer cause the computer to carry out the method of claim 11.

19. A vehicle having a vehicle part manufactured in a production line in which it has been decided by the method of claim 11 whether scheduled maintenance or unscheduled maintenance is to be carried out.
